(19) United States
(12) Patent Application Publication
(10) Pub. No.: US 2013/0174362 A1
(43) Pub. Date: Jul. 11, 2013

(54) Water-Powered Automobile Cleaning Apparatus and Related Methods

(71) Applicant: Joseph Edwards, Port of Spain (TT)

(72) Inventor: Joseph Edwards, Port of Spain (TT)

(21) Appl. No.: 13/735,265

(22) Filed: Jan. 7, 2013

Related U.S. Application Data
(60) Provisional application No. 61/583,278, filed on Jan. 5, 2012.

(51) Int. Cl. B60S 3/06

(52) U.S. Cl. CPC B60S 3/06
USPC 15/53.1

(57) ABSTRACT

The present invention is directed to a fluid-powered automobile cleaning and detailing apparatus that utilizes a fluid, such as water from a garden hose, to generate a highly pressurized stream that forcibly rotates an array of turbine blades within a head assembly communicating with an output shaft that projects outside of the head assembly to rotatably power an attached cleaning or detailing implement.

### CROSS-REFERENCE TO RELATED APPLICATIONS

This application seeks priority to U.S. Provisional Patent Application Ser. No. 61/583,278 filed on Jan. 5, 2012 entitled “Water-Powered Automobile Cleaning Apparatus and Related Methods,” the contents of which are incorporated by reference herein.

### FIELD OF THE INVENTION

The present invention generally relates to the field of automobile maintenance. More particularly, the present invention pertains to the field of automotive car washing apparatuses and methods.

### BACKGROUND OF THE INVENTION

Automotive cleaning and maintenance is a common pastime for those individuals wishing to keep their cars in an aesthetically pleasing state of cleanliness. Unfortunately, this typically equates to either costly expenditures on laborers who clean cars by hand or, alternatively, back-breaking manual labor by the owner. Other portions of the car wash process, such as cleaning the tiny nooks and crevasses are tediously slow processes, taking large amounts of time to complete. Another issue that often arises when washing a car is the difficulty reaching the roof or other elevated portions of a vehicle or trailer.

Long-handled brushes can help reach difficult portions of a vehicle or trailer, but the manual nature of such apparatuses does not eliminate the need for a large exertion of manual labor. In fact, the mechanical disadvantage of wielding a long brush can actually lead to a greater physical exertion than would otherwise be necessary using short-handled brushes.

Another notable disadvantage to washing cars manually, using sponges, manual brushes, chamois, and rags, is the constant need to re-wet the washing implement. This inefficiently causes unnecessary breaks, further increasing the time needed for the car washing process.

Additionally, there are a number of separate beautification operations that an owner of a vehicle may wish to employ. These can include rinsing, washing, scrubbing, drying, and buffing, for example, and no single apparatus is capable of being used for all operations.

To solve many of these issues, cleaning apparatuses have been devised that can overcome some of these problems. For example, small brushes are used to manually clean in small spaces, and electric buffers are used to wax or buff a vehicle, but there is no single apparatus that can address all of these issues.

There is a need for an effective, cheaply produced, and convenient-to-use apparatus that reduces the amount of manual labor expended while washing a car, can reach far away vehicle regions, can clean within small spaces, does not need to be constantly re-wet, and can be used for all common car cleaning operations, including buffing and waxing.

### SUMMARY OF THE INVENTION

The present invention addresses the aforementioned issues related to car washing. The invention is directed to a powered automobile cleaning apparatus utilizing water, such as water from a garden hose, or other fluids which travels through an elongated handle, through a pressure nozzle in a head assembly, creating a highly pressurized stream of water or other fluid that forcibly rotates an array of turbine blades within the head assembly communicating with an output shaft that projects outside of the head assembly. The output shaft is adaptable for holding brushes, scrubbing pads, buffing pads, waxing pads, and auto detailing implements. The head assembly also comprises an articulable water, or other fluid, exit nozzle that provides water, or other fluid, for the area of the automobile being washed. The exit nozzle can be turned off and the fluid redirected so that operations such as waxing or buffing can commence without fluid being deposited on the surface being waxed or buffed.

In at least one embodiment, the cleaning apparatus comprises a head assembly including an inlet for receiving pressurized fluid, a turbine assembly mounted to a shaft projecting outwardly from the head assembly, and an exit conduit for channeling fluid from the head assembly proximate the head assembly. The turbine assembly is contained within the head assembly and structured to rotate the shaft extending from the head assembly as pressurized liquid passes through the head assembly. The apparatus further includes an implement removably attached to the shaft extending from the head assembly. The apparatus also includes a handle containing a first end and a second end operatively connected by a central conduit. The first end is structured to attach to a pressurized fluid source and the second end is in sealed communication with the head assembly to supply pressurized fluid to the head assembly via its inlet.

In another embodiment, the present invention is directed to a cleaning apparatus, as previously mentioned, that further includes a return conduit and a selection valve. The return conduit diverts fluid away from the apparatus. The selection valve is structured to selectively channel fluid into one of the return conduit or exit conduit, depending on the desired use of the apparatus.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of an embodiment of the invention;

FIG. 2 is a side view inside the head assembly of an embodiment of the invention; and

FIG. 3 is a perspective view of an embodiment of the invention.

### DETAILED DESCRIPTION

The present invention will now be described more fully in the description provided herein. It is to be understood that the invention may be embodied in many different forms and should not be construed as limited to the embodiments set forth herein. Rather, these embodiments are provided so that this disclosure may be thorough and complete, and will convey the scope of the invention to those skilled in the art.

The present invention is directed to a type of car-washing and beautification apparatus that is adaptable to perform a number of different related tasks, such as washing, rinsing, scrubbing, buffing, and waxing, while minimizing the exertion of manual labor normally associated with performing such operations by hand.

Throughout the specification, water is described as the fluid utilized by the present invention. It would be understood by those skilled in the art that numerous types of fluids may be utilized with the present invention to accomplish the same result. As such, the present invention is meant to utilize any type of flowable fluid.

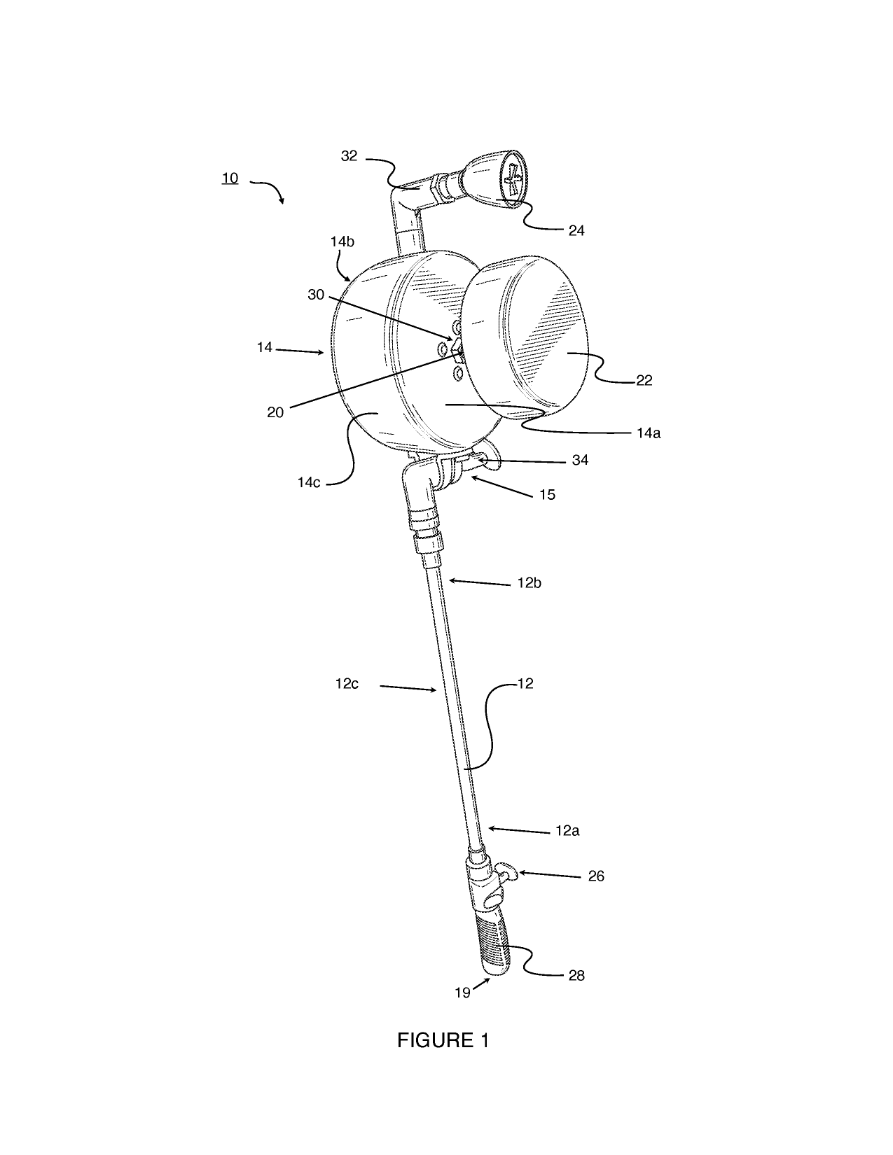

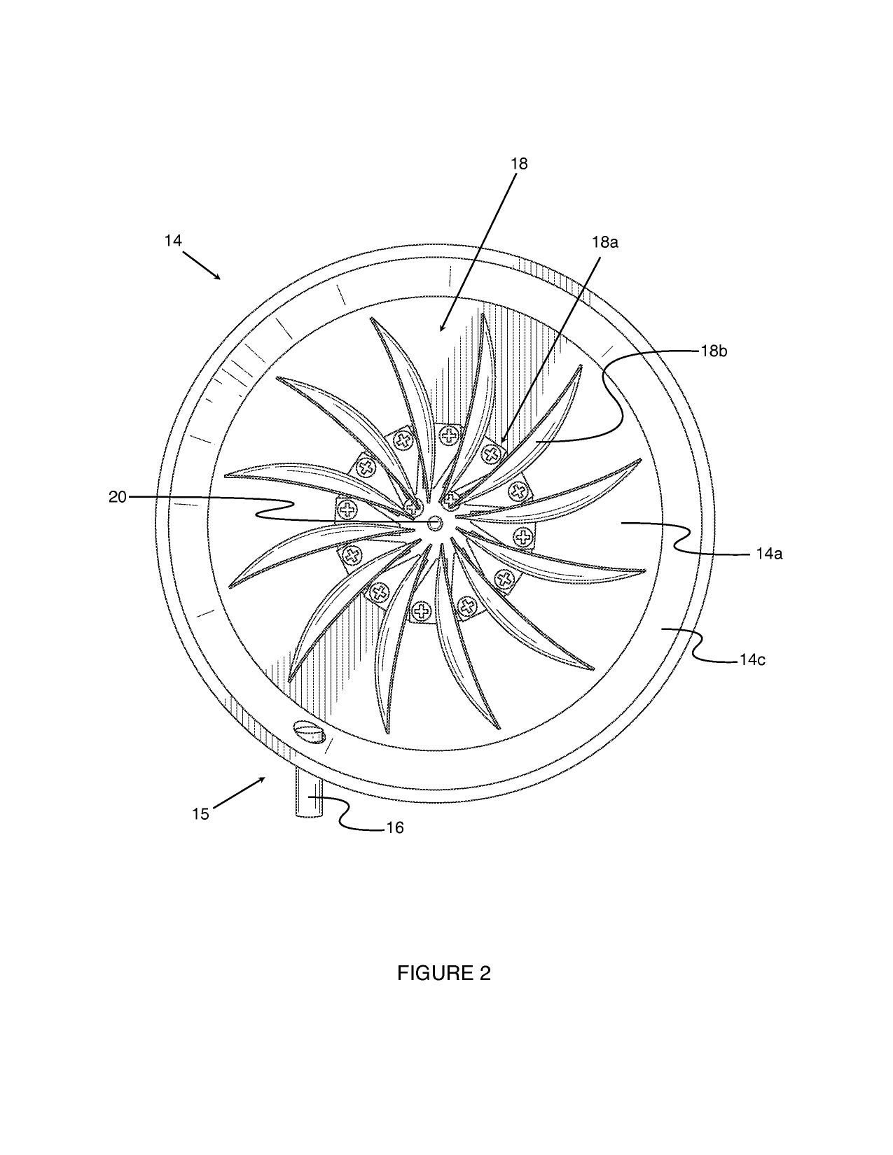

In an overview of one embodiment shown in FIG. 1, the apparatus 10 comprises a handle 12 to aid in reaching difficult to reach places, such as car roofs, while washing a car. As such, the handle 12 may be telescoping. The handle 12 is attached to a head assembly 14 (may be referred to solely as “head” or “the head”). The handle 12 is hollow and attachable to a garden hose or other source of water, or other fluid, under pressure. Water from the garden hose travels through the handle 12 and into the head 14 via an inlet 15. The water passes via the inlet 15 through a pressure nozzle 16, as seen in FIG. 2, as it enters the head 14. The pressure nozzle 16 may be structured to concentrate a fluid spray pattern and increase the pressure of fluid entering the head assembly 14.

The head 14 further contains a turbine assembly 18 within that is mounted to a rotatable shaft 20 that projects through and outwardly from the head 14 and is rotatably propelled by a jet of water created by the water flowing through the pressure nozzle 16 into the head 14. The turbine 18, as shown in FIG. 2, is structured to rotatably attach to the shaft 20, which extends through and exits the head 14, where a plurality of interchangeable implements 22, each designed for a particular task such as scrubbing or buffing, may be removably attached to the shaft 20. When water actuates the turbine 18, the shaft 20 turns, thereby turning the implement 22 attached to the shaft 20.

In some embodiments, after the water turns the turbine 18, it exits the head assembly 14 to a spray-head 24 in communication with the head assembly 14 via an exit conduit 32. This water is used to wash or rinse the vehicle; therefore, the exit conduit 32 may be structured to channel and release fluid proximal to the head assembly 14 via, e.g., a spray-head 24.

The handle 12 of this apparatus 10 is a hollow tube or conduit, and water passes from a first end of the handle 12a to a second end of the handle 12b through the interior hollow cavity, or central conduit 12c, operatively connecting each end of the handle. The handle 12 is made from at least one of metal, plastic, PVC, and any other material as would be understood by those skilled in the art. In one embodiment, the handle 12 comprises a telescoping handle that extends to increase the length of the handle 12. The junction that allows the telescoping action is such that the joint is water-tight so that water does not leak from the inside of the hollow handle 12 to the exterior of the handle 12.

The first end of the handle 12a is structured to include a connection point 19 adaptable to accept a water source or pressurized fluid source. In one embodiment, this is a thread adaptable to accept a common residential garden hose. A seal, such as a rubber grommet, nitrile o-ring, or any seal known in the art is used to prevent the leaking of fluid from the hose-to-handle junction. In another embodiment, a metal or plastic quick disconnect fitting is used to sealedly secure the hose to the handle.

Proximate the first end 12a of the handle 12 is a first valve 26 that is structured to control the flow of water or other pressurized fluid into the handle 12. The valve type may be that of a compression valve, cartridge valve, disc valve, ball vale, or any valve known in the art. Proximate the first end of the handle 12 is a gripping surface 28 molded to promote a secure hand grip on the handle. This gripping surface 28 may be made from plastic, rubber, metal, PVC, neoprene, or any other material known in the art.

The second end of the handle 12b sealedly communicates with a head assembly 14 to supply pressurized fluid to the head assembly 14 via the inlet 15. In one embodiment, this junction can pivot to accommodate varying head angles. Communicating with the second end of the handle 12b is the pressure nozzle 16 (see FIG. 2) designed to increase the pressure of the water entering the head 14 and concentrate a water spray pattern.

With reference to FIG. 2, the head assembly 14 has a top wall 14a, a bottom wall 14b, and a side wall 14c that connects the top 14a and bottom 14b wall. The turbine assembly 18 is housed within the head assembly 14. The turbine assembly 18 is comprised of a shaft mount 30 attached to the top wall 14a of the head assembly 14. The shaft mount 30 is a pillow block, plummer block, bracket, plate, or any means of mounting a rotatable shaft known in the art. The shaft mount 30 comprises at least one of a bearing, bushing, and seal. A shaft 20, having a first end, a second end, and a middle portion is rotatably engaged to the shaft mount 30. The first end of the shaft projects within the head assembly, and the second end of the shaft projects outwardly towards the exterior of the head assembly 14 passing through a hole in the top wall 14a of the head assembly. The hole in the top wall 14a comprises a seal that allows the shaft 20 to project through the hole, yet prevents water from leaking out of the head through the hole. In one embodiment, the second end of the shaft does not project outside the top wall of the head assembly, but is rather substantially flush with the plane of the top wall.

A propeller element 18a is attached to the first end of the shaft 20. In one embodiment, the propeller element 18a comprises a plurality of vanes 18b that are mounted in a radial pattern. The vanes 18b are flat, curved, twisted, cupped or any other shape used on propellers known in the art, and spaced in a manner known in the art to promote the rotation of the propeller element when a jet of water contacts the propeller vanes 18b. The pressure nozzle 16 is mounted proximate the side wall of the head assembly 14c, and is aimed at the vanes 18b of the propeller element 18a at an angle, depending on the particular configuration of the propeller element 18a, such that a jet of water projects from the pressure nozzle 16 and contacts the propeller vanes 18b, causing the propeller 18a to rotate, which in turn causes the shaft 20 attached to the propeller 18a to rotate.

The second end of the shaft is capable of accepting an implement 22, such as a scrubbing brush that rotates when the shaft rotates. The second end of the shaft accepts the implement 22 by screw thread, bolt, clamp, dowel, quick disconnect, pin, friction, taper, hook and loop, or any other attachment means known in the art.

The head assembly 14 further comprises an exit conduit 32 for the water utilized to rotate the propeller element 18. The exit conduit 32 prevents water from accumulating in the head assembly 14 by providing a route for the water used to rotate the propeller element 18a to escape and also be used for car washing purposes. The exit conduit 32 extends outwardly from the head assembly 14 and communicates with a spray head 24. The spray head 24 changes the shape of what would otherwise be bulk water flow to a spray appropriate for washing, scrubbing, and rinsing an automobile. The spray head 24 pivots to be aimed in a range of 300° simultaneously in two axes.

Furthermore, the second end 12b of the handle 12 in sealed communication with the head assembly 14 may be pivotable to accommodate varying head assembly 14 angles relative to the handle 12.

In one embodiment, a second valve 34 that is structured to control the flow of water or other fluid into the spray head 24 is proximate the spray head 24. The valve type is selected from a group consisting of a compression valve, cartridge valve, disc valve, ball valve, and any valve known in the art.

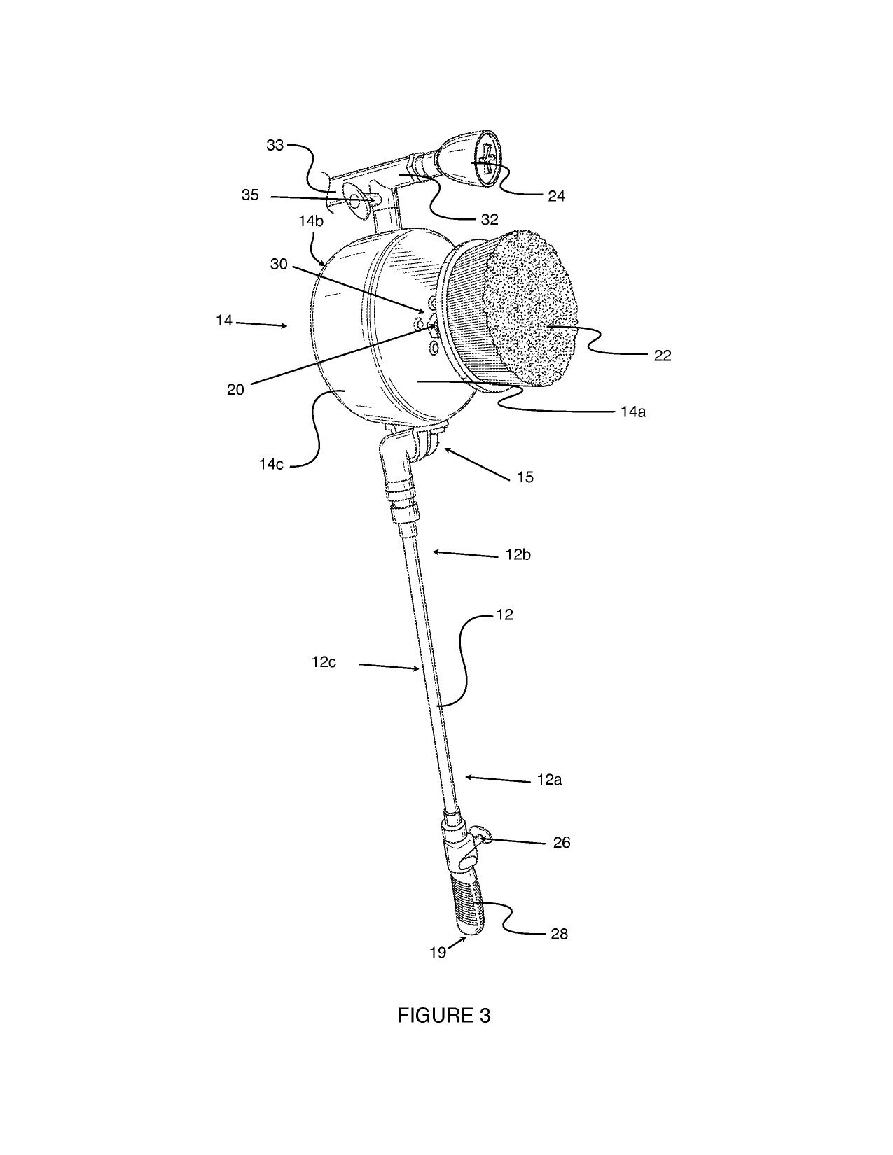

In another embodiment, there is a return conduit 33 that provides an exit route for fluid to be evacuated away from the head assembly 14 and diverts fluid from exiting the exit conduit 32 and spray head 24. This is so an implement 22 such as a buffing or waxing pad can be used to buff or polish a vehicle without water being deposited on the vehicle. The return conduit 33 is a length that provides fluid to escape the apparatus 10 without wetting the surface. The return conduit may optionally be anchored to the handle of the apparatus 10. Furthermore, such embodiments, as illustrated in FIG. 3, utilize a selection valve 35 that is structured to selectively channel fluid into one of the return conduit 33 or exit conduit 32. Typically, the selection valve 35 includes a handle that a user can position to select the route of fluid through either the return conduit 33 or exit conduit 32 depending on the intended use of the apparatus 10 at the time.

Some embodiments of the present invention utilize the return conduit 33 to return fluid to the source of the pressurized fluid (e.g., a water reservoir of a fluid pump). As such, the return conduit 33 may be structured to channel fluid to the source of the pressurized fluid such that the fluid is recycled.

The implements 22 attached to the second end of the shaft rotate due to the propeller element-mediated rotation of the shaft 20. A plurality of different implements 22 provides numerous functionalities to the apparatus. The implements 22 are brushes (see FIG. 3), chamois, wool pads, micro-fiber pads, sponges, scrubbing pads, buffing pads, dusters, and any other cleaning or detailing implement 22 known in the art. In one embodiment, the implement 22 attaches to the second end of the shaft which may comprise a substantially flat disc with a surface that is a first side of a hook and loop fastener. The implements 22 comprise the complimentary second side of a hook and look attachment designed to attach to the surface of the flat disc. A plurality of different implements 22 provides numerous functionalities to the apparatus. The implements 22 may include brushes, chamois, wool pads, micro-fiber pads, sponges, scrubbing pads, buffing pads, dusters, and any other car cleaning implement 22 known in the art.

This invention is not limited to a car-washing tool, for the second end of the shaft 20 is capable of engaging a generator head for the production of electrical energy from the rotational energy actuated by the hydraulic forces acting on the propeller element 18a. This can be scaled from a hand-held apparatus to a larger apparatus capable of municipal power production.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A cleaning apparatus, comprising:
a head assembly comprising an inlet for receiving pressurized fluid, a turbine assembly mounted to a shaft projecting outwardly from the head assembly, and an exit conduit for channeling fluid from the head assembly, wherein the turbine assembly is contained within the head assembly and structured to rotate the shaft extending from the head assembly as pressurized liquid passes through the head assembly;
an implement, the implement removably attached to the shaft extending from the head assembly; and
a handle comprising a first end and a second end operatively connected by a central conduit, the first end structured to attach to a pressurized fluid source and the second end in sealed communication with the head assembly to supply pressurized fluid to the head assembly via the inlet.

2. The cleaning apparatus of claim 1, further comprising a pressure nozzle in the inlet for concentrating a fluid spray pattern and increase the pressure of fluid entering the head assembly.

3. The cleaning apparatus of claim 1, further comprising means for telescoping the handle.

4. The cleaning apparatus of claim 1, further comprising a first valve proximate the first end of the handle for controlling the flow of pressured fluid into the handle.

5. The cleaning apparatus of claim 1, further comprising a second valve proximate the second end of the handle for controlling the flow of fluid into the head assembly.

6. The cleaning apparatus of claim 1, further comprising means at the first end for attaching the apparatus to a water hose.

7. The cleaning apparatus of claim 1, wherein the second end in sealed communication with the head assembly is pivotable to accommodate varying head assembly angles.

8. The cleaning apparatus of claim 1, wherein the turbine assembly comprises a propeller element having a plurality of vanes mounted in a radial pattern.

9. The cleaning apparatus of claim 8, wherein the inlet comprises a pressure nozzle adapted to aim at the vanes.

10. The cleaning apparatus of claim 1, wherein the exit conduit extends outwardly from the head assembly and communicates with a spray head that selectively directs the flow of fluid.

11. The cleaning apparatus of claim 10, further comprising a return conduit in fluid communication with the head assembly and structured to selectively divert fluid away from the spray head.

12. The cleaning apparatus of claim 1, wherein the implement is selected from the group comprising a brush, a chamois, a pad, a sponge, and a duster.

13. A cleaning apparatus, comprising:
a head assembly comprising an inlet for receiving pressurized fluid, a turbine assembly mounted to a shaft projecting outwardly from the head assembly, an exit conduit for channeling and releasing fluid proximal to the head assembly, a selection valve, and a return conduit for diverting fluid away from the apparatus, wherein the turbine assembly is contained within the head assembly and structured to rotate the shaft extending from the head assembly as pressurized liquid passes through the head assembly, wherein the selection valve is structured to selectively channel fluid into one of the return conduit or exit conduit;
an implement, removably attached to the shaft extending from the head assembly; and
a handle comprising a first end and a second end operatively connected by a central conduit, the first end structured to attach to a pressurized fluid source and the second end in sealed communication with the head assembly to supply pressurized fluid to the head assembly via the inlet.

14. The cleaning apparatus of claim 13, wherein the inlet includes a pressure nozzle structured to concentrate a fluid spray pattern and increase the pressure of fluid entering the head assembly.

15. The cleaning apparatus of claim 13, further comprising means for attaching the first end to a water hose.

16. The cleaning apparatus of claim 13, wherein the second end in sealed communication with the head assembly is pivotable to accommodate varying head assembly angles.

17. The cleaning apparatus of claim 13, wherein the turbine assembly includes a propeller element comprising a plurality of vanes mounted in a radial pattern.

18. The cleaning apparatus of claim 13, wherein the exit conduit extends outwardly from the head assembly and communicates with a spray head that selectively directs the flow of fluid proximate to the head assembly.

19. The cleaning apparatus of claim 13, wherein the return conduit is structured to channel fluid to the source of the pressurized fluid such that the fluid is recycled.

20. The cleaning apparatus of claim 13, wherein the implement is selected from the group comprising a brush, a chamois, a pad, a sponge, and a duster.
